(19) United States
(12) Patent Application Publication
(10) Pub. No.: US 2008/0140798 A1
(43) Pub. Date: Jun. 12, 2008

(54) STORAGE ADAPTER AND METHOD THEREOF

(75) Inventors: Chien-Hsing Liu, Shijr City (TW); Kuo-Chou Tseng, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/608,491

(22) Filed: Dec. 8, 2006

(51) Int. Cl. G06F 15/16

(52) U.S. Cl. 709/208

(57) ABSTRACT

A storage adapter and method thereof are disclosed. The storage adapter includes a central processing unit (CPU), a first interpreting controller, an analyzer and a simulating controller. The central processing unit (CPU) processes the control procedure between the client computers and the server computers. The first interpreting controller interprets a plurality of commands from the client computer to the sever computers to be transmitted on the network. The analyzer analyzes the commands of the client computer and responds to some of the commands for the sever computers. The simulating controller simulates the storage units of the server computers as if the storage adapter is directly and locally connected to the client computer such that the client computer is capable of accessing the storage units of the server computers.

### FIELD OF THE INVENTION

The present invention relates to a storage device and method thereof, and more particularly to a network storage adapter and method thereof.

### BACKGROUND OF THE INVENTION

FIG. 1 is a conventional system diagram depicting a local computer for accessing a plurality of storage units connected to remote server computers via a network. The system of accessing the storage units includes the local computer 100, the remote server computers 104 and the storage units 102 connected to each of the remote server computer 104. The local computer 100 remotely reads/writes the data stored in the storage units 102 of each server computer 104 by employing a network interface card (not shown) installed thereon. The remote storage unit 102 can be a hard disk drive (HDD) and a compact disk random only memory (CD-ROM).

However, since the local computer 100 accesses the data within the storage units 102 first and then the accessed data are merely stored in the HDD of the local computer 100, it is quite inconvenient in view of information access management. On the other hand, time-out issue might be a problem because the storage units 102 do not directly connect to the local computer 100. Further, the information is not easily portable because the accessed data is stored in the storage units 102 connected to each of the remote server computer 104 such that the data in the storage unit 102 cannot be efficiently utilized by the local computer 100.

Therefore, there is a need to develop a network storage adapter such that each user is able to conveniently and easily access the remote storage unit.

### SUMMARY OF THE INVENTION

One object of the present invention is to provide a storage adapter for allowing a client computer to control at least one storage unit connected to a server computer via a network.

Another object of the present invention is to provide a storage adapter for solving the time-out issue between the client computer and the server computer.

In a first embodiment of the present invention, the storage adapter includes a central processing unit (CPU), a first interpreting controller, a communicating controller, an analyzer, a simulating controller, memory, a security device and a compressing/de-compressing device. The storage adapter allows a client computer to control the storage units connected to the server computers via a network. For example, the client computer reads or writes the data stored in the storage units of the server computers by employing the storage adapter. The server computer further includes a second interpreting controller.

The central processing unit (CPU) processes the control procedure between the client computer and the server computers. The first interpreting controller is coupled to the CPU, and interprets a plurality of commands from the client computer to the sever computers to be transmitted on the network so that the second interpreting controller redirects the storage units of the server computers to the client computer on the basis of the commands. Thus, the client computer can access the storage units as if the client computer substantially reads or writes its own storage units locally. The analyzer is coupled to the CPU and the first interpreting controller and analyzes the commands of the client computer and responds to some of the commands for the sever computers. The simulating controller is coupled to the CPU, the first interpreting controller and the client computer, and simulates the storage units of the server computers as if the storage adapter is directly and locally connected to the client computer such that the client computer is capable of accessing the storage units of the server computers. In one embodiment, the simulating controller can be USB device controller for communicating with the client computer according to USB standard.

In a second embodiment of the present invention, the storage adapter includes a central processing unit (CPU), a first interpreting controller, a communicating controller, an analyzer, a plurality of simulating controllers, memory, a security device and a compressing/de-compressing device. The storage adapter in the second embodiment is similar to the storage adapter in the first embodiment except the installation location of the storage adapter. The storage adapter is locally connected to the client computers and remotely coupled to the server computer via a network. The server computer includes a second interpreting controller and a plurality of storage units.

The central processing unit (CPU) processes the control procedure among the client computers and server computer. The first interpreting controller interprets a plurality of commands from the client computer to the sever computers into information to be transmitted on the network for redirecting the storage units of the server computer to the client computers on the basis of the commands. Thus, each of client computers can access the storage units like the client computers substantially read or write its own storage units locally. The analyzer analyzes the commands of the client computer and responds to some of the commands for the sever computers. The simulating controllers are coupled to the CPU and the first interpreting controller, and each of simulating controllers is correspondingly connected to each of client computers. The simulating controllers simulates the storage unit of the client computer as if the client computer directly and locally connected to the storage units such that the client computers connected to the simulating controllers are capable of accessing the storage unit of the server computer. Preferably, since a plurality of simulating devices are coupled to the server computer, the storage units of the server computer can be shown on each of the client computers.

The control architecture mainly includes a host driver, a storage device driver connected to the device host, a signal-managing program, a storage-managing program, a first application program run on the CPU and the memory, a second application program coupled to the first application program, and an adapter driver.

The first interpreting controller interprets the commands into the reading command and the writing command, and some commands except the reading and writing commands. The analyzer analyzes the attributes of the interpreted commands so that the storage adapter is capable of filtering the analyzed results to determine to transmit the reading command and writing command to the server computer and contain the exceptive commands to be in the client computer. Thus, only the reading command and the writing command are processed by the server computer and the exceptive commands are performed within the client computer locally. Therefore, the flow rate of commands and data between the client computer and server computer is considerably reduced, thereby solving the time-out problem.

The steps of performing storage adapter are described as follows:

The second interpreting controller of the server computer identifies the storage units and exports or returns the identified storage units to the storage adapter for sharing content via the network. The storage adapter finds the exported storage units available on the network. The simulating controller of the storage adapter simulates the found storage units for the client computer as if the storage units are directly and locally connected to the client computer.

Then, the storage adapter determines that how many server computers, found storage units or storage capacities thereof can be connected to the client computer according to the user request from the client computer. The first interpreting controller interprets the commands from the client computer and transmits the interpreted commands to the second interpreting controller. The analyzer analyzes the attributes of the interpreted commands and responds to some of the commands for the sever computer. The second interpreting controller receives the reading command and the writing command from the storage adapter and put the content of the storage units on the network according to the user request so that the client computer can access the content.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a conventional system diagram depicting a local computer for accessing a plurality of storage units connected to remote server computers via a network;

FIG. 2 is a schematic diagram depicting a storage adapter for controlling a plurality of storage units connected to a plurality of server computers according to a first embodiment of the present invention;

FIG. 3 is a schematic diagram depicting the first interpreting controller for interpreting the commands and data transmitted between the client computer and the server computers shown in FIG. 2 according to the first embodiment of the present invention;

FIG. 4A is a schematic diagram depicting a storage adapter enabling client computers to control a plurality of storage units connected to a server computer according to a second embodiment of the present invention;

FIG. 4B is a schematic diagram depicting a storage adapter enabling a plurality of client computers to control a plurality of storage units connected to a server computer according to a third embodiment of the present invention;

FIG. 4C is a schematic diagram depicting a storage adapter enabling a plurality of client computers to control a storage unit connected to a server computer according to a fourth embodiment of the present invention;

FIG. 5 is a schematic diagram depicting the first interpreting controller for interpreting the commands and data transmitted from the client computer to server computers shown in FIG. 4A, FIG. 4B and FIG. 4C according to one embodiment of the present invention;

FIG. 6 is a schematic diagram depicting software control architecture of the storage adapter shown in FIG. 2 according to one embodiment of the present invention; and

FIGS. 7A and 7B are flow charts of performing storage adapter according to one embodiment of the present invention.

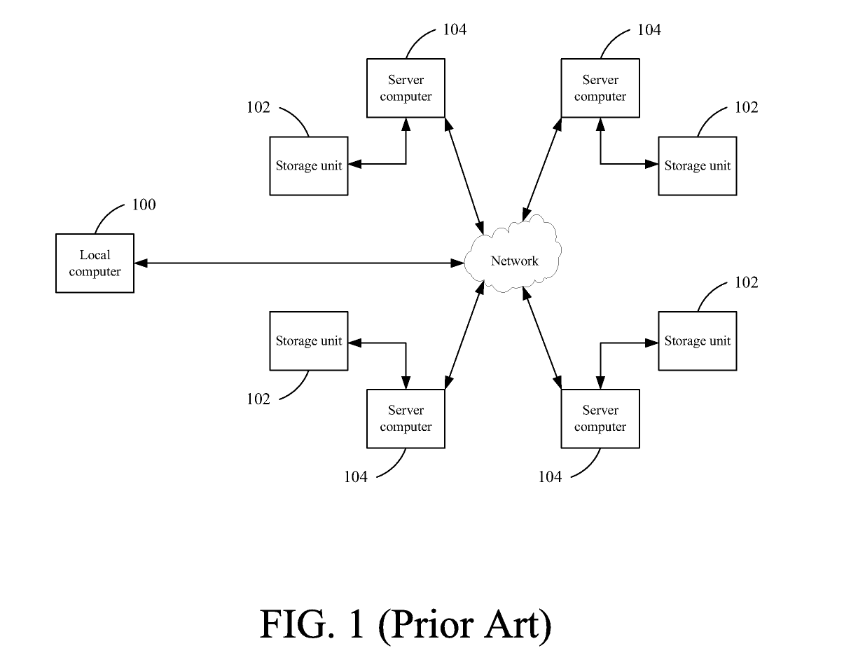

### DETAILED DESCRIPTION OF THE PREFERRED EMBODIMENTS

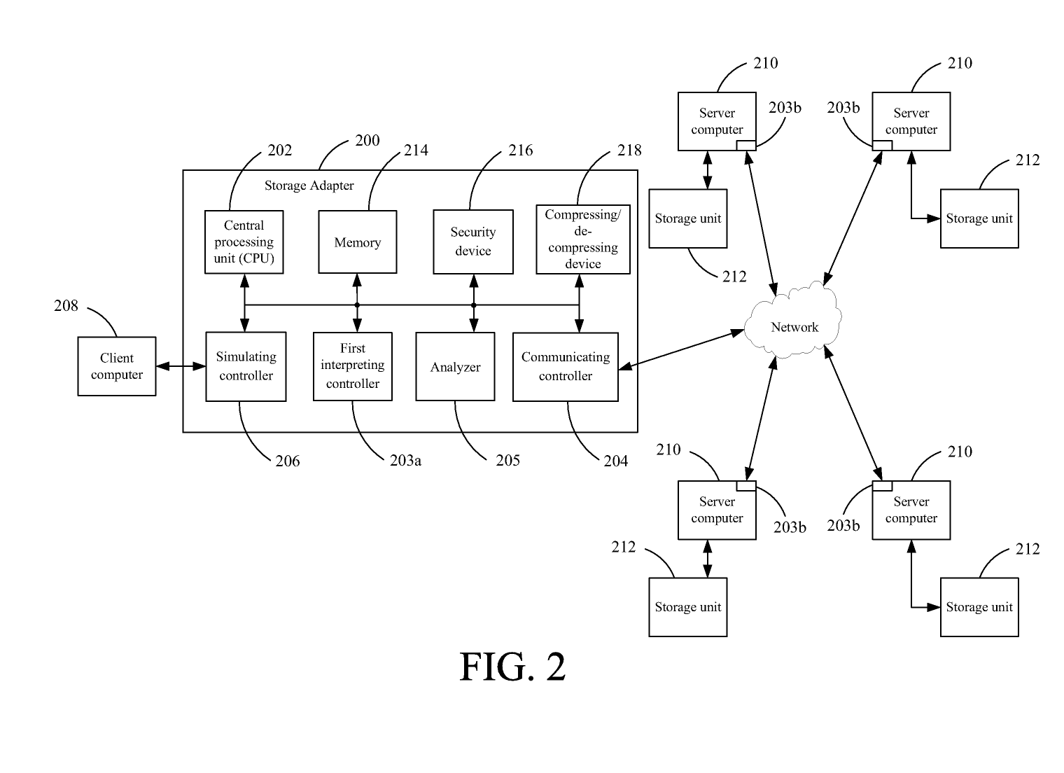

FIG. 2 is a schematic diagram depicting a storage adapter 200 for controlling a plurality of storage units 212 connected to the server computers 210 according to a first embodiment of the present invention. The storage adapter 200 includes a central processing unit (CPU) 202, a first interpreting controller 203a, a communicating controller 204, an analyzer 205, a simulating controller 206, memory 214, a security device 216 and a compressing/de-compressing device 218. The storage adapter 200 allows a client computer 208 to control the storage units 212 connected to the server computers 210 via a network. For example, the client computer 208 reads or writes (or termed as “accesses”) the data stored in the storage units 212 of the server computers 210 by employing the storage adapter 200. The server computer 210 further includes a second interpreting controller 203b. Preferably, the storage unit 212 is a floppy disk drive (FDD), a hard disk drive (HDD), a compact disk read only memory (CD-ROM), a file folder having a disk-image file serving as a format of CD-ROM, DVD-ROM standards, a physical storage unit or logical storage unit, or the combinations thereof.

As shown in FIG. 2, the central processing unit (CPU) 202 processes the control procedure (such as the operation of accessing commands) between the client computer 208 and the server computers 210. The first interpreting controller 203a is coupled to the CPU 202, and interprets a plurality of commands from the client computer 208 to the sever computers 210 into information to be transmitted on the network so that the second interpreting controller 203b redirects the storage units 212 of the server computers 210 to the client computer 208 on the basis of the commands. Thus, the client computer 208 can access the storage units 212 as if the client computer 208 substantially reads or writes its own storage units locally. The analyzer 205 is coupled to the CPU 202 and the first interpreting controller 204 and analyzes the commands of the client computer 208 and responds to some of the commands for the sever computers 210. The simulating controller 206 is coupled to the CPU 202, the first interpreting controller 203a and the client computer 208, and simulates the storage units 212 of the server computers 210 as if the storage adapter 200 is directly and locally connected to the client computer 208 such that the client computer 208 is capable of accessing the storage units 212 of the server computers 210. In one embodiment, the simulating controller 206 can be an USB device controller for communicating with the client computer 208 according to USB standard.

Continuously referring to FIG. 2, the storage adapter 200 further includes a communicating device 204, a security device 216 and a compressing/de-compressing device 218. The communicating device 204 is coupled to the CPU 202, the first interpreting controller 203a and the server computers 210 and communicates with the server computer 210 via the network remotely. The security device 216 connected to the CPU 202 to secure the commands to be transmitted between the client computer 208 and the server computers 210. In one embodiment, the security device 216 complies with an Advanced Encryption Standard or the like. The storage adapter 200 is disposed between the client computer 208 and server computers 210 so that the storage adapter 200 is able to insure the safety of the commands and data by employing the security device 216 for controlling the accessing authorization of the storage units 212 of the server computers 210. The compressing/de-compressing device 218 is coupled to the first interpreting controller 203a and the communicating device 204 for compressing/decompressing the commands and data.

In the present invention, the server computer 210 shares the content stored in the storage units 212, and the storage adapter 200 allows the client computer 208 to control the server computers 210 for accessing the content shared by the server computer 210 via the network and the accessed content is temporarily stored in the memory 214 for the client computer 208. In one embodiment, the storage adapter 200 is a portable device which can be plugged into the client computer 208 so that the client computer 208 is able to access conveniently the content of the server computer 210. Therefore, the storage adapter 200 effectively expands the storage unit 212 of the server computer 210 to the memory 214 of storage adapter 200 for increasing the utilization of the storage units 212 of the server computers 210.

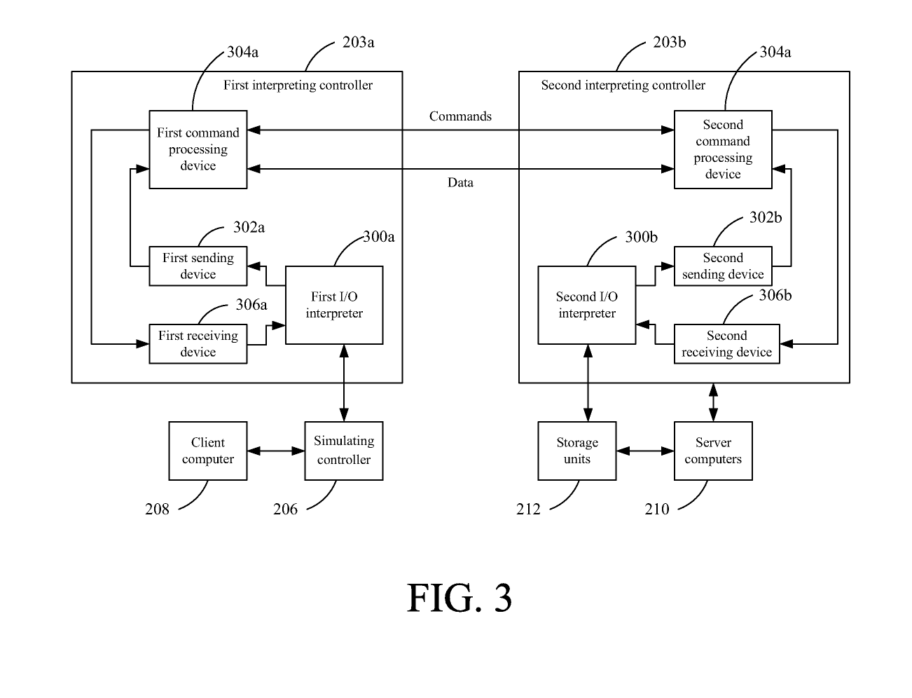

Please refer to FIG. 2 and FIG. 3 which is a schematic diagram depicting the first interpreting controller for interpreting the commands and data transmitted between the client computer and the server computers shown in FIG. 2 according to one embodiment of the present invention.

The first interpreting controller 203b further includes a first input/output (I/O) interpreter 300a connected to the simulating controller 206, a first sending device 302a connected to the first input/output (I/O) interpreter 300a, a first command processing device 304a connected between the first sending device 302a and second interpreting controller 203b, a first receiving device 306a connected between the first input/output (I/O) interpreter 300a and the first command processing device 304a.

Similarly, the second interpreting controller 203b is similar to the first interpreting controller 203a and further includes a second input/output (I/O) interpreter 300b connected to the storage unit 212 of the server computer 210, a second sending device 302b connected to the second input/output (I/O) interpreter 300b, a second command processing device 304b connected between the second sending device 302b and first interpreting controller 203a, a second receiving device 306b connected between the second input/output (I/O) interpreter 300b and the second command processing device 304b.

(S600) The second input/output (I/O) interpreter 300b identified the storage unit 212. The second sending device 302b sends the identified information to the second command processing device 304b and the second command processing device exports the identified information to the first interpreting controller 203a of the storage adapter 200. (S602) According to the identified information from the second interpreting controller 203b, the first command processing device 304b of the first interpreting controller 203a finds the exported storage units available on the network. The first receiving device 306b receives the information from first interpreting controller 203a to be transmitted to the simulating controller 206 via the first input/output (I/O) interpreter 300a. (S604) The simulating controller 206 of the storage adapter 200 simulates the found storage units for the client computer 208. (S606) The first sending device 302b sends the simulation result to the first command processing device 304a for determining that how many server computers 210, found storage units or storage capacities thereof can be connected to the client computer 208 according to the user request from the client computer 208.

(S608) The first input/output (I/O) interpreter 300a of first interpreting controller 203a interprets the commands from the client computer 208 and transmits the interpreted commands to the first command processing device 304a via the first sending device 302b. (S610) The first command processing device 304a analyzes the interpreted commands and responds some of the commands to the second command processing device 304b. (S616) The second command processing device 304b of the second interpreting controller 203b receives the reading command and the writing command from the first interpreting controller 203a. The second receiving device 306b receives the reading command and the writing command such that the content of the storage unit 212 is put on the network for the client computer 208 according to the user request. The client computer 208 is able to read content from the storage unit 212 or write data to the storage unit 212.

The storage adapter 200 can improve time-out issue which means no signal response when a signal, e.g. control signal or the like, is sent from the client computer 208 to server computers 210. Since the first interpreting controller 203a interprets the commands so that the second interpreting controller 203b redirects the storage units 212 of the server computers 210 to the client computer 208 on the basis of the commands, the storage adapter 200 can filter the analyzed results to determine to transmit the reading command and writing command to the server computer 210 and contain the exceptive commands to be in the client computer 208 Therefore, the flow rate between the client computer 208 and server computer 210 is considerably reduced, thereby solving the time-out problem.

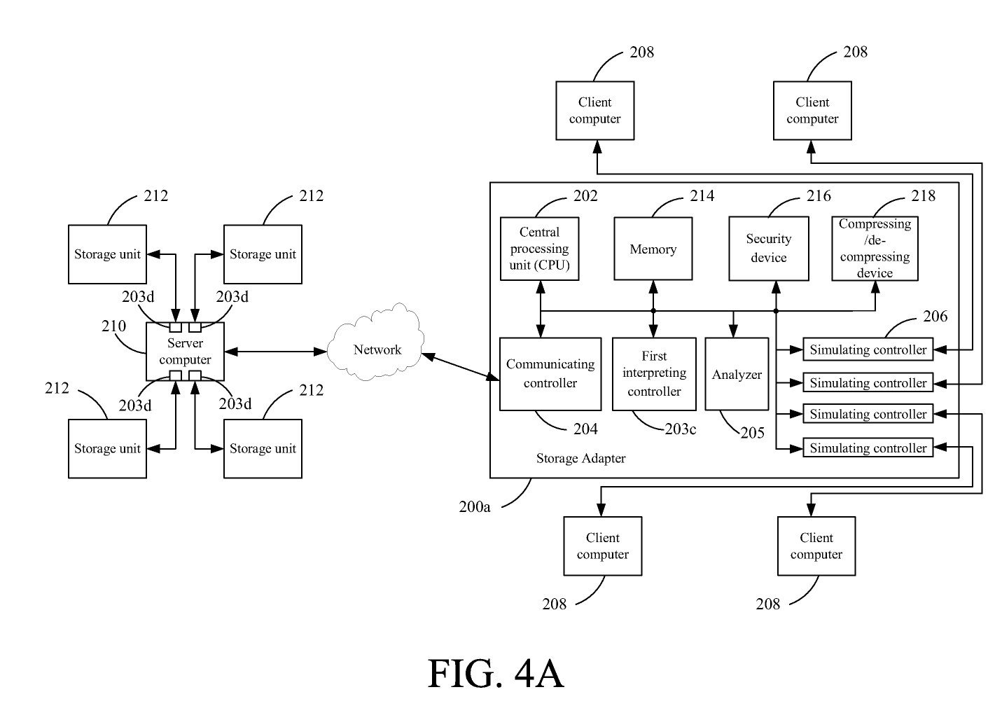

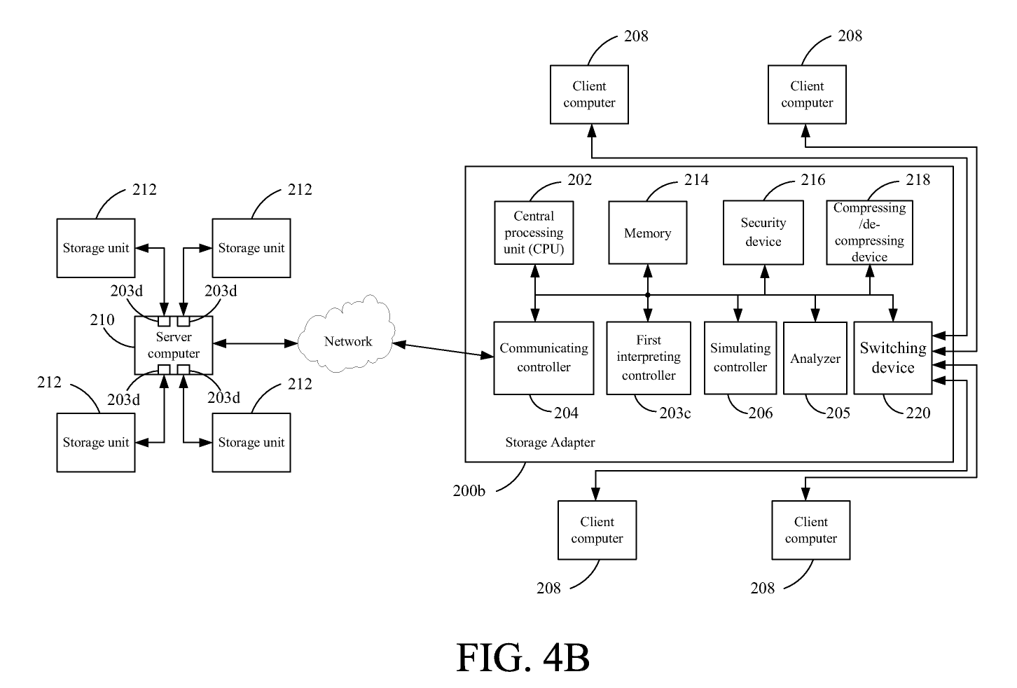

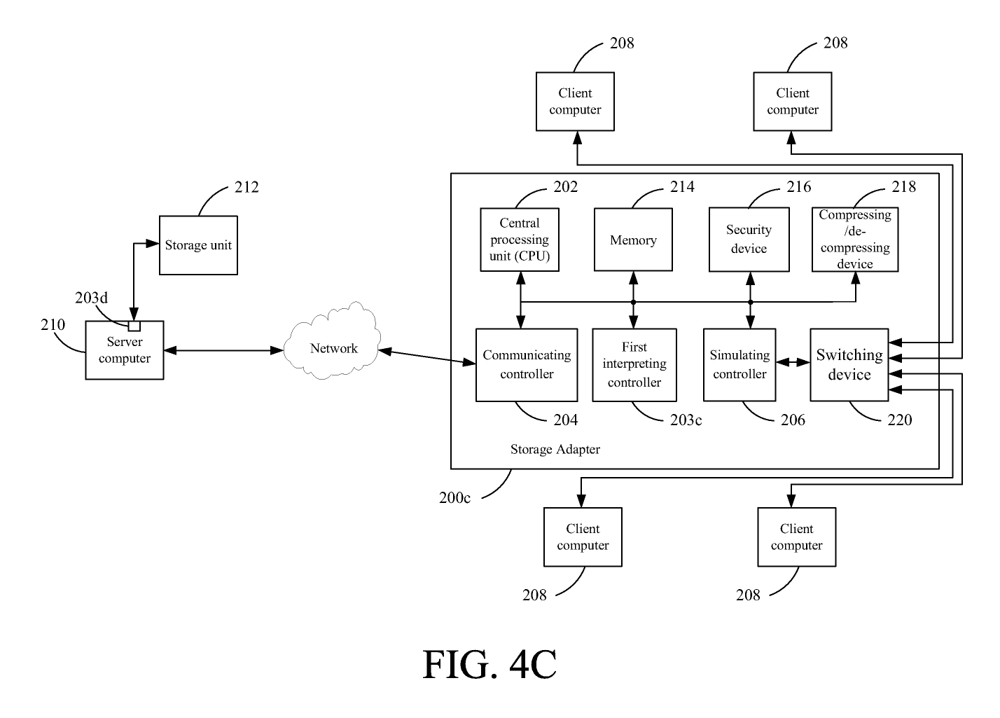

FIG. 4A is a schematic diagram depicting a storage adapter 200a enabling a plurality of client computers 208 to control a plurality of storage units 212 connected to a server computer 210 according to a second embodiment of the present invention. The storage adapter 200a includes a central processing unit (CPU) 202, a first interpreting controller 203c, a communicating controller 204, an analyzer 205, a plurality of simulating controllers 206, memory 214, a security device 216 and a compressing/de-compressing device 218. The storage adapter 200a in the second embodiment is similar to the storage adapter 200 in the first embodiment except the installation location of the storage adapter 200a. The storage adapter 200a is locally connected to the client computers 208 and remotely coupled to the server computer 210 via a network. The server computer 210 includes a second interpreting controller 203d and a plurality of storage units 212.

The central processing unit (CPU) 202 processes the control procedure among the client computers 208 and server computer 210. The first interpreting controller 203c interprets a plurality of commands from the client computer 208 to the sever computers 210 into information to be transmitted on the network for redirecting the storage units 212 of the server computer 210 to the client computers 208 on the basis of the commands. That is, the drive numbers of the storage units 212 of the server computer 210 are renamed new drive numbers correspondingly and shown on the client computers 208. Thus, each of client computers 208 can access the storage units 212 like the client computers 208 substantially read or write its own storage units locally. The analyzer 205 analyzes the commands of the client computer 208 and responds to some of the commands for the sever computers 210. The simulating controllers 206 are coupled to the CPU 202 and the first interpreting controller 203c, and each of simulating controllers 206 is correspondingly connected to each of client computers 208. The simulating controllers 206 simulates the storage unit 212 of the client computer 208 as if the client computer 210 directly and locally connected to the storage units 212 such that the client computers 208 connected to the simulating controllers 206 are capable of accessing the storage unit 212 of the server computer 210. Preferably, since a plurality of corresponding simulating devices 206 are coupled to the server computer 210, the storage units 212 of the server computer 210 can be shown on each of the client computers 208. The detail descriptions of the rest of components in FIG. 4A can be referred to FIG. 2 and are thus omitted here.

FIG. 4B is a schematic diagram depicting a storage adapter 200b enabling a plurality of client computers 208 to control a plurality of storage units 212 connected to a server computer 210 according to a third embodiment of the present invention. The storage adapter 200b includes a central processing unit (CPU) 202, a first interpreting controller 203c, a communicating controller 204, an analyzer 205, a simulating controller 206, memory 214, a security device 216, a compressing/de-compressing device 218 and a switching device 220. The storage adapter 200b in the third embodiment is similar to the storage adapter 200a in the second embodiment except the amount of the simulating device 206 and further includes the switching device 220. The switching device 220 couples the switching unit 206 to the client computers 208 for switching between the client computers 208 to select one of the client computers 208 so that the storage units 212 of the server computer 210 are shown on one of the client computers 208. The detail descriptions of the rest of components in FIG. 4B can be referred to FIG. 4A and are thus omitted here.

FIG. 4C is a schematic diagram depicting a storage adapter 200c enabling a plurality of client computers 208 to control a storage unit 212 connected to a server computer 210 according to a fourth embodiment of the present invention. The storage adapter 200c in the third embodiment is similar to the storage adapter 200b in the third embodiment except the amount of storage unit 212 of the server computer 210. Additionally, person skilled in the art should be noted that the simulating controller 206 shown in FIG. 4C can be substituted with the simulating controllers 206 shown in FIG. 4A for the client computers 208, and the switching device 220 shown in FIG. 4C can be omitted. The detail descriptions of the rest of components in FIG. 4C can be referred to FIG. 4B and are thus omitted here.

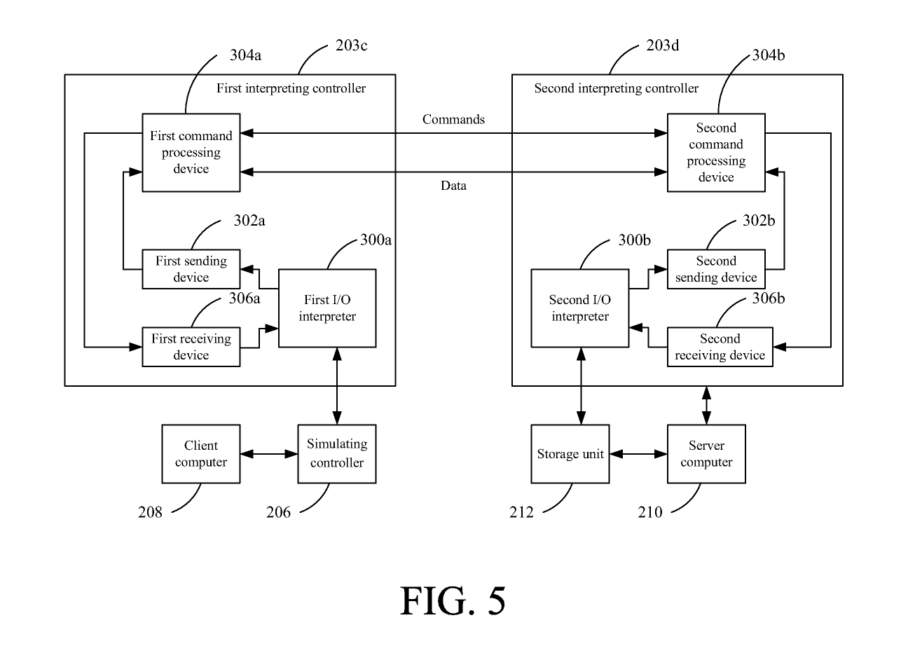

Please refer to FIG. 3, FIG. 4A, FIG. 4B, FIG. 4C and FIG. 5 which is a schematic diagram depicting the first interpreting controller 203c for interpreting commands and data transmitted between the client computer and the server computers shown in FIG. 4A, FIG. 4B and FIG. 4C according to one embodiment of the present invention. The components shown in FIG. 5 are similar to the components shown in FIG. 3 except the amounts and allocations of the client computers 208, the server computer 210 and the storage units connected to the server computer 210. It should be noted that the simulating controller 206 can be substituted with a switching device to switch between the client computers 208 for selecting one of them. Additionally, a plurality of simulating controller 206 can be utilized to serve each of client computers 208.

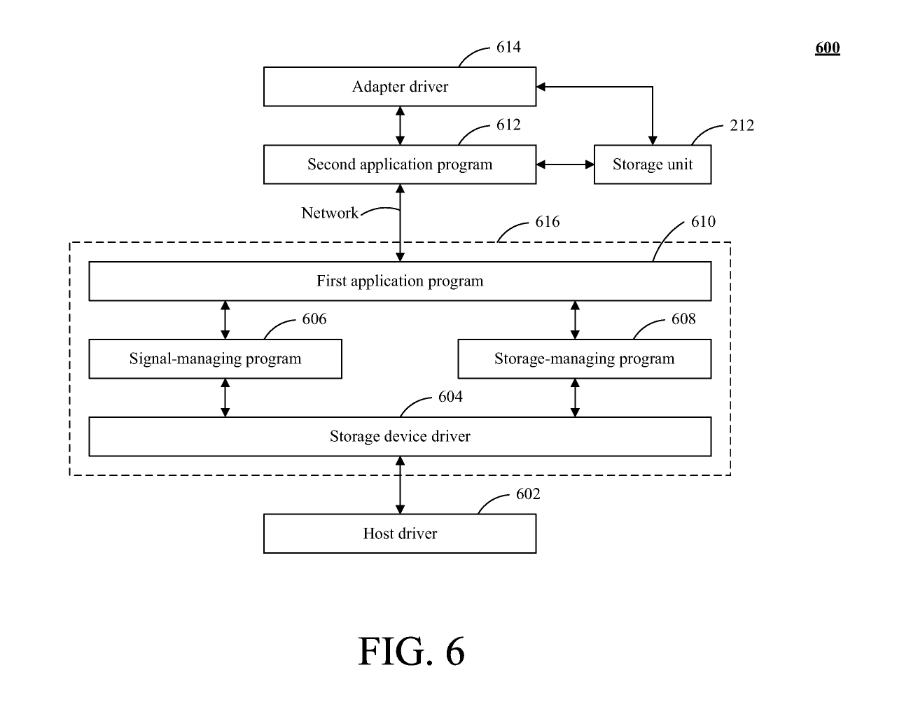

Please refer to FIG. 2 and FIG. 6 depicting software control architecture of the storage adapter shown in FIG. 2 according to one embodiment of the present invention. The control architecture 600 can be implemented by the storage adapter 200 shown in FIG. 2. The control architecture 600 mainly includes a host driver 602, a storage device driver 604 connected to the device host 602, a signal-managing program 606, a storage-managing program 608, a first application program 610 run on the CPU 202 and the memory 214, a second application program 612 coupled to the first application program 610, and an adapter driver 614. Basically, the dashed line block 616 is implemented by using the storage adapter 200.

The client computer 208 performing the host driver 602 communicates with the simulating controller 206 performing the storage device driver 604 of the storage adapter 200. The signal-managing program 606 is implemented in the first interpreting controller 203a and interprets a plurality of commands from the client computer 208 to the sever computers 210 into information to be transmitted on the network. The storage-managing program 608 is performed in the analyzer 205 and for analyzing the commands of the client computer 208 and responding to some of the commands for the sever computers 210. The first application program 610 communicates with the second application program 612 so that the storage adapter 200 can interact with the server computer 210. The second application program 612 is run on the server computer 210 and the adapter driver 614 is run on the second interpreting controller 203b of the server computer 210.

The first interpreting controller 203a interprets the commands into the reading command and the writing command, and some commands except the reading and writing commands. The analyzer 205 analyzes the attributes of the interpreted commands so that the storage adapter 200 is capable of filtering the analyzed results to determine to transmit the reading command and writing command to the server computer 210 and contain the exceptive commands to be in the client computer 208. Thus, only the reading command and the writing command are processed by the server computer 210 and the exceptive commands are performed within the client computer 208 locally. Therefore, the flow rate of commands and data between the client computer 208 and server computer 210 is considerably reduced, thereby solving the time-out problem.

Continuously referring to FIG. 2, FIG. 4A, FIG. 4B and FIG. 4C, in one embodiment, the storage adapter (200, 200a, 200b, and 200c) includes a plurality of ports (not shown) for connecting a plurality of client computers 208 and server computers 210. A kind of KVM operating control signals over a network or an internet protocol (IP) address is used to manage the server computers 210 while the KVM is connected to a computer. Meanwhile, the storage adapter (200, 200a, 200b, and 200c) is connected to the server computers 210 via the ports and coupled to the computer via a network, e.g. cable or wireless, so that the storage adapter (200, 200a, 200b, and 200c) is able to monitor the control procedure of the KVM.

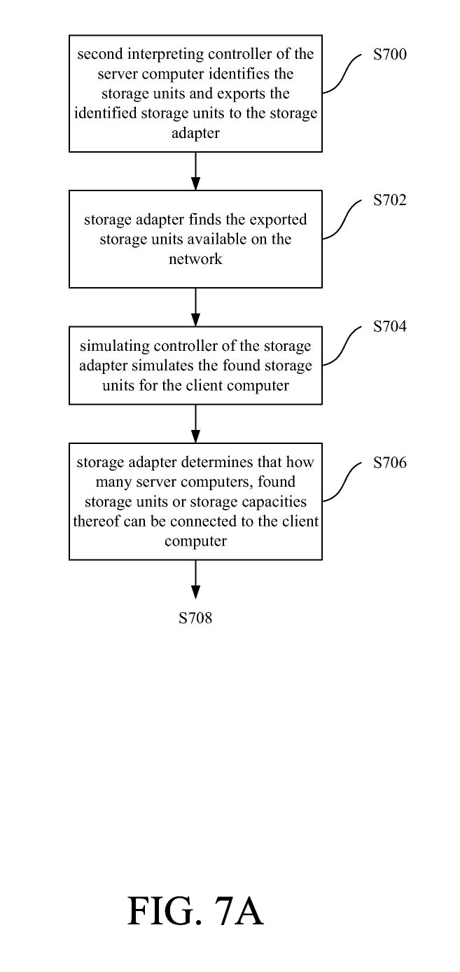

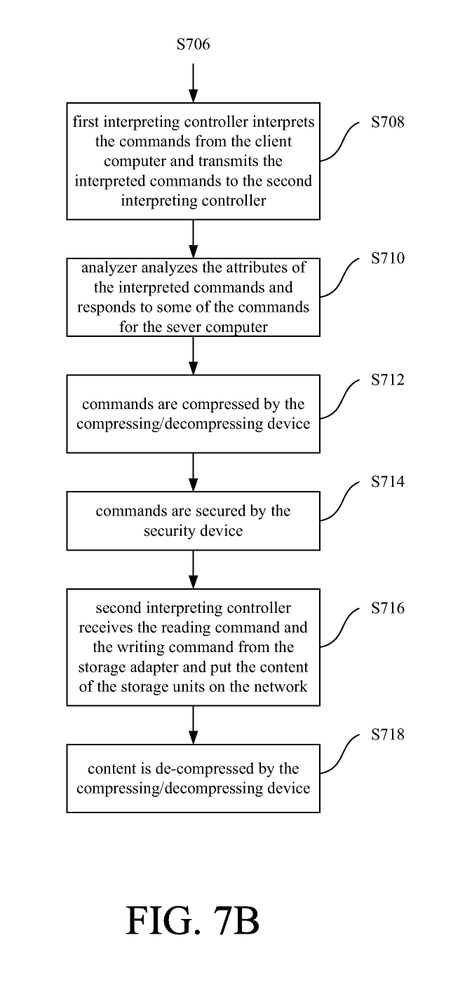

Please refer to FIG. 2, FIG. 4A, FIG. 4B, FIG. 4C and FIGS. 7A and 7B depicting a flow chart of performing storage adapter according to one embodiment of the present invention. The flow chart includes the steps of: (S700) the second interpreting controller 203b of the server computer 210 identifies the storage units and exports or returns the identified storage units to the storage adapter for sharing content via the network; (S702) the storage adapter 200 finds the exported storage units available on the network. That is, the server computer 210 actively shares the storage units 212 and the storage adapter 200 connects the storage units 212 via the second interpreting controller 203b; (S704) the simulating controller 206 of the storage adapter 200 simulates the found storage units for the client computer 208 as if the storage units are directly and locally connected to the client computer; (S706) the storage adapter 200 determines that how many server computers 210, found storage units or storage capacities thereof can be connected to the client computer 208 according to the user request from the client computer 208;

(S708) the first interpreting controller 203a interprets the commands from the client computer 208 and transmits the interpreted commands to the second interpreting controller 203b; (S710) the analyzer 205 analyzes the attributes of the interpreted commands and responds to some of the commands for the sever computer 210; (S712) before the analyzer 205 responds to some of the commands for the sever computer 210, the commands are compressed by the compressing/decompressing device 218; (S714) the commands are secured by the security device 216 to insure the command safety from the client computer 208 to server computer 210; (S716) the second interpreting controller 203b receives the reading command and the writing command from the storage adapter 200 and put the content of the storage units 212 on the network according to the user request so that the client computer 208 can access the content. Thus, the second interpreting controller 203b redirects the storage units 212 of the server computers 210 to the client computer 208 on the basis of the commands; and (S718) after the storage adapter 200 accessing the content from the server computers 212, the content is de-compressed by the compressing/decompressing device 218.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A storage adapter for allowing a client computer to control at least one storage unit connected to a server computer via a network, the storage adapter comprising:
a central processing unit (CPU), processing the control procedure between the client computer and the server computer;
a first interpreting controller coupled to the CPU, interpreting a plurality of commands from the client computer to the sever computer into information to be transmitted on the network;
an analyzer coupled to the CPU and the first interpreting controller, analyzing the commands and responding to some of the commands for the sever computer; and
at least one simulating controller coupled to the CPU, the first interpreting controller, the analyzer and the client computer, simulating the storage unit of the server computer as if the storage unit is directly and locally connected to the client computer such that the client computer is capable of controlling the storage unit of the server computer.

2. The storage adapter of claim 1, wherein the commands comprises a writing command and a reading command, and the analyzer responds to a portion of commands except the writing command and the reading command.

3. The storage adapter of claim 2, wherein the server computer responds to the writing command and the reading command.

4. The storage adapter of claim 1, further comprising a switching unit coupled to the simulating controller for switching between a plurality of client computers to select one of the client computers.

5. The storage adapter of claim 4, wherein a plurality of simulating controllers are connected to the client computers correspondingly for simulating the at least one storage unit of the server computer for the client computers.

6. The storage adapter of claim 1, wherein the at least one storage unit is the one selecting from a group consisting of FDD, HDD, CD-ROM, a folder having a disk-image file and the combinations thereof.

7. The storage adapter of claim 1, wherein the simulating controller is an USB device controller for communicating with the client computer according to an USB standard.

8. The storage adapter of claim 1, further comprising a security device connected to the CPU to secure the commands to be transmitted between the client computer and the server computer.

9. The storage adapter of claim 8, wherein the security device complies with an Advanced Encryption Standard.

10. A KVM switch for allowing a client computer to control a plurality of storage units connected to a plurality of server computer via a network, the KVM switch comprising:
a central processing unit (CPU), processing the control procedure between the client computers and the server computers;
a first interpreting controller coupled to the CPU, interpreting a plurality of commands from the client computer to the sever computer into information to be transmitted on the network;
an analyzer coupled to the CPU and the first interpreting controller, analyzing the commands and responding to some of the commands for the sever computers; and
a plurality of simulating controllers coupled to the CPU, the first interpreting controller, the analyzer and the client computers, simulating the storage units of the server computers as if the storage units are directly and locally connected to the client computers such that the client computers are capable of controlling the storage units of the server computers.

11. The KVM switch of claim 10, wherein the commands comprises a writing command and a reading command, and the analyzer responds to a portion of commands except the writing command and the reading command.

12. The KVM switch of claim 11, wherein the server computers respond to the writing command and the reading command.

13. The KVM switch of claim 10, further comprising a switching unit coupled to the simulating controller for switching between a plurality of client computers to select one of the client computers.

14. The KVM switch of claim 13, wherein a plurality of simulating controllers are connected to the client computers correspondingly for simulating the at least one storage unit of the server computers for the client computers.

15. The KVM switch of claim 10, wherein the at least one storage unit is the one selecting from a group consisting of FDD, HDD, CD-ROM, a folder having a disk-image file and the combinations thereof.

16. The KVM switch of claim 10, wherein the simulating controller is an USB device controller for communicating with the client computers according to an USB standard.

17. The KVM switch of claim 10, further comprising a security device connected to the CPU to secure the commands to be transmitted between the client computers and the server computers.

18. The KVM switch of claim 17, wherein the security device complies with an Advanced Encryption Standard.

19. A method for allowing a client computer connected to a storage adapter to control at least one storage unit connected to a server computer via a network, the method comprising the steps of:
identifying the storage unit and exporting the identified storage units to the storage adapter by the server computer on the network;
finding the exported storage unit available on the network;
simulating the found storage units for the client computer by the storage adapter as if the storage unit is directly and locally connected to the client computer;
interpreting the commands from the client computer and transmitting the interpreted commands to the server computer by the storage adapter; and
analyzing the interpreted commands and responding to some of the commands for the sever computer.

20. The method of claim 19, after the step of simulating the found storage units for the client computer, further comprising a step determining that the amount of the storage units can be connected to the client computer.

21. The method of claim 19, wherein the commands comprises a writing command and a reading command, and the analyzer responds to a portion of commands except the writing command and the reading command.

22. The method of claim 19, wherein the server computers respond to the writing command and the reading command.

23. The method of claim 19, before the step of responding to some of the commands for the sever computer, further comprising a step of compressing the commands.

24. The method of claim 23, after the step of compressing the commands, further comprising a step of securing the commands.
